(19) United States
(12) Patent Application Publication
(10) Pub. No.: US 2022/0108312 A1
(43) Pub. Date: Apr. 7, 2022

(54) METHODS, SYSTEMS, AND DEVICES FOR SECURE CROSS-BORDER PAYMENTS WITH HIGH TRANSACTION THROUGHPUT

(71) Applicant: Tunnel International Inc., Boston, MA (US)

(72) Inventor: Frank Makrides, Belmont, MA (US)

(21) Appl. No.: 17/554,680

(22) Filed: Dec. 17, 2021

Related U.S. Application Data
(63) Continuation of application No. PCT/US20/38661, filed on Jun. 19, 2020.
(60) Provisional application No. 62/863,311, filed on Jun. 19, 2019.

(51) Int. Cl. G06Q 20/38; G06Q 20/36; G06Q 20/40; G06Q 20/02

(52) U.S. Cl. CPC G06Q 20/3829; G06Q 20/363; G06Q 20/381; G06Q 20/40145; G06Q 20/023; G06Q 20/38215

(57) ABSTRACT

Disclosed herein are methods, systems, and devices for providing secure national and/or cross-border payments with high transaction throughput using a hybrid of centralized payment system and cryptographically secure distributed ledger technologies? The system combines the benefits of a centralized system, including the ability to deposit and withdraw fiat currency following bank regulations, “Know Your Customer”/“Know Your Business” (KYC/KYB), “Anti-Money Laundering” (AML), with high security of cryptographically secure distributed ledger technology to solve security issues. A multi-chain structure is used to implement the methods with instant settlement, high security, integrity and scalability.

### PRIORITY CLAIM

This application is a continuation of International Patent Application No. PCT/US2020/038661, filed on Jun. 19, 2020, which claims the benefit of U.S. Provisional Patent Application No. 62/863,311, filed on Jun. 19, 2019, the entire contents of both are incorporated herein by reference.

### TECHNICAL FIELD

The present disclosure generally relates to cryptocurrencies and payment systems. More specifically, the disclosure applies to cryptocurrencies and payment systems as related to secure cross-border payment systems.

### BACKGROUND

Existing digital assets and/or cryptocurrencies, like Bitcoin, are too volatile to be widely adopted as a payment system and be accepted by major merchants. If a cryptocurrency is used to pay for goods and/or services, its exchange rate to USD (or other fiat currency) may significantly change by the end of the day and the merchant risks to lose money.

There is a class of cryptocurrencies, called stable coins, aimed to solve the volatility problem. These systems may have a cost to support stability and/or transactions to send coins may not be free and/or they may not conceal the balance and/or they may still deviate from the pegged currency by few percent and/or they may have a risk of “black swan” event and/or they may have scalability problems.

Another potential issue with cryptocurrencies to be accepted by major merchants is regulatory risks “Know Your Customer” (KYC) and “Anti-Money Laundering” (AML) rules may not be followed in decentralized system.

On the other side, traditional centralized payment systems are less secure. These systems traditional centralized payment have security issues including:
A) Attacker contacts the phone provider and, by pretending to be the phone number owner, asks to port the number to his SIM. Then the attacker is able to reset the password to the payment application overcoming 2-factor authentication, like reading SMS and can spend other person's money
B) Attacker steals mobile device, overcomes 2-factor authentication and after successful reset password procedure can spend other person's money Two-factor authentication using short message service (SMS) and/or email may not work well as person with access to the phone usually has access to read SMS and access to email client without the need to enter additional password.
C) Attacker steals mobile device, overcomes security questions, and after successful reset password procedure can spend other person's money (security questions may not be secure enough, as attacker can use the person's social media profiles to figure out the answers).
D) Attacker gains access to the mobile device where payment application is secured by application password and biometric data validations, overcomes 2-factor authentication (same as (b) and
(c)), and gains the access to the payment system database to disable biometric data validations. As a result the attacker can spend the person's money.
E) Attacker gains the access to the database and changes the balance (or other data) in a way that will be unnoticeable to the system.
F) In case of a data loss event, it may be hard to identify integrity issues.
G) In case of a data loss event, it may be hard for the customers to prove that the lost transaction took place.
H) Attacker gains the access to the databases and destroys the data including the backups.
I) Attacker gains the access to Customers and Merchants balances and other data.

Another issue is the limited transaction throughput and settlement times in existing payment systems. Internet of Things (IoT) and gaming micro transactions are increasing the requirements on the payment system architecture to support higher throughput and speed and faster settlement times. Also many payment gateways are charging high fees to process payments making micro transactions unfeasible.

Another layer of complexity is cross-border payments which are usually associated with even higher cost, slower speed and throughput.

Accordingly, a need exists for new methods, systems, and devices for providing advanced levels of security to conduct national and/or cross-border payments with high throughput while being cost efficient and having high usability.

### SUMMARY

Disclosed herein are methods, systems, and devices for solving the technological problem of providing an advanced level of security to conduct national and/or cross-border payments with high throughput, being cost efficient and with high usability.

These methods, systems, and devices combine the benefits of a centralized system, including the ability to deposit and withdraw fiat currency following bank regulations, “Know Your Customer” (KYC) and “Anti-Money Laundering” (AML), with security of cryptographically secure distributed ledger technology to solve security issues (e.g. including issues A through I described above), and at the same time increase the transaction throughput. These methods, systems, and devices provide cost effective cross-border payment system, which includes the cost effective system and methods to deposit/withdraw fiat currency into the system with conversion to digital assets with the combination of my proprietary Tunnel Multi-Chain technology to provide zero-cost, instant settlement, private, secure and linearly scalable cross-border transactions.

These methods, systems, and devices provide secure cross-border payments with high transaction throughput using a hybrid of centralized payment system and cryptographically secure distributed ledger technology with triple signed blocks. The system combines the benefits of a centralized system, including the ability to deposit and withdraw fiat currency following bank regulations, “Know Your Customer”/“Know Your Business” (KYC/KYB), AML, with high security of cryptographically secure distributed ledger technology. The Tunnel Multi-Chain technology and transaction processing system and methods are introduced to enable improved security and to allow the system to scale linearly by adding more computing nodes to support high transaction throughput requirements, also to enable to do cost-effective and instant settlement. There are no existing solutions to provide the same level of security and/or the same transaction throughput. The methods, systems, and devices provide for cost effective deposit/withdraw of fiat currency into/from the system with conversion to digital assets. Disclosed herein are how to securely backup and restore the wallet private keys to/from the centralized system for better usability. Also it is disclosed that the methods defined in the claims can be implemented entirely as a hardware component, for example as a specialized circuit(s), entirely as a software component or a combination of both. The combination of the described methods form the next generation of highly secure, high throughput and cost efficient cross-border payment systems.

### BRIEF DESCRIPTION OF THE DRAWINGS

The present embodiments are illustrated by way of example and are not intended to be limited by the figures of the accompanying drawings. In the drawings:

FIG. 1 depicts the system and methods for national and/or cross-border payments using the hybrid architecture of centralized payment system and cryptographically secure distributed ledger in accordance with embodiments of the present disclosure.

FIG. 2 depicts Tunnel Multi-Chain block structure and how it is formed based on the “Send request” of the sender and “Receive request/Auto-confirm” of the receiver in accordance with embodiments of the present disclosure

FIG. 3 depicts Tunnel Multi-Chain structure for national payments where each chain includes a series of Tunnel Account Blocks and represents an individual account and tracks balance changes in accordance with embodiments of the present disclosure.

FIG. 4 depicts the system and methods for the cross-border transaction flow in case the transactions in the distributed ledger are batched and then a single transfer between FBO accounts is made in accordance with embodiments of the present disclosure.

FIG. 5 depicts the system and methods for the cross-border transaction flow in case the transactions in the distributed ledger are not batched and every transaction updates FBO accounts balances in accordance with embodiments of the present disclosure.

FIG. 6 depicts Tunnel Multi-chain structure for cross-border payments where each chain includes a series of Tunnel Account Blocks and represents an individual account and tracks balance changes in accordance with embodiments of the present disclosure.

FIG. 7 depicts the system and methods for the main transaction flow in case the receiver sends Auto-confirm for the specific sender in accordance with embodiments of the present disclosure.

FIG. 8 depicts the system and methods for the main transaction flow in case the receiver sends the payment request for the specific sender in accordance with embodiments of the present disclosure.

FIG. 9 depicts the system and methods to solve the described security issues in accordance with embodiments of the present disclosure.

FIG. 10 depicts the cost effective system and methods to deposit/withdraw fiat currency into/from the system with conversion to digital assets in accordance with embodiments of the present disclosure.

FIG. 11 depicts the system with end to end flow for cost effective cross-border payments with high security and high throughput in accordance with embodiments of the present disclosure.

FIG. 12 depicts the system and methods to securely backup and restore the wallet private keys to/from the centralized system in accordance with embodiments of the present disclosure.

FIG. 13 depicts one example of a computing device to send/receive national and/or cross-border payments, deposit/withdraw the fiat currency, backup/restore the private key, process and validate a payment transaction in accordance with embodiments of the present disclosure.

### DETAILED DESCRIPTION

The present disclosure relates to methods, devices, and systems that provide improvements to the security of national and cross-border payments. Included are improvements for payments from mobile devices, and improvements to transaction throughput that provide cost efficient payment solutions and good user experience. This present disclosure also builds upon the methods, devices and systems disclosed in PCT Patent Application No. PCT/US2019/059738 entitled “METHODS, SYSTEMS, AND DEVICES FOR CONCEALING ACCOUNT BALANCES IN LEDGERS,” (Attorney Docket No. 1115/2 PCT) which was filed on Nov. 5, 2019; PCT Patent Application No. PCT/US2019/062907 entitled “METHODS, SYSTEMS, AND DEVICES FOR ON-CHAIN STABLE TRANSACTION IN DECENTRALIZED CRYPTOCURRENCIES,” (Attorney Docket No. 1115/3 PCT) which was filed on Nov. 25, 2019; and PCT Patent Application No. PCT/US2019/068904 entitled “METHODS, DEVICES, AND SYSTEMS FOR SECURE PAYMENTS,” (Attorney Docket No. 1115/4 PCT) which was filed on Dec. 30, 2019; the disclosures of which are all incorporated herein by reference in their entireties.

The following description and figures are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The disclosed methods, systems, and devices solve the technological problem of providing secure and cost effective cross-border payments. Details of the specific ledger implementation, data structures and transaction flows are disclosed herein, however, it is to be understood that these are merely examples and specific structural and functional details should not be interpreted as limiting but rather should help to understand the concept and serve as the basis of the claims. The examples show mostly cross-border payments, however, they apply also to national payments inside a country. Also examples below show mostly payments from mobile devices, however, the system and methods apply to any computing device. The examples herein are between sender and receiver, which can be applied to peer-to-peer and/or business-to-business and/or consumer-to-business payment transactions or any other two or more multiple party payment methodologies.

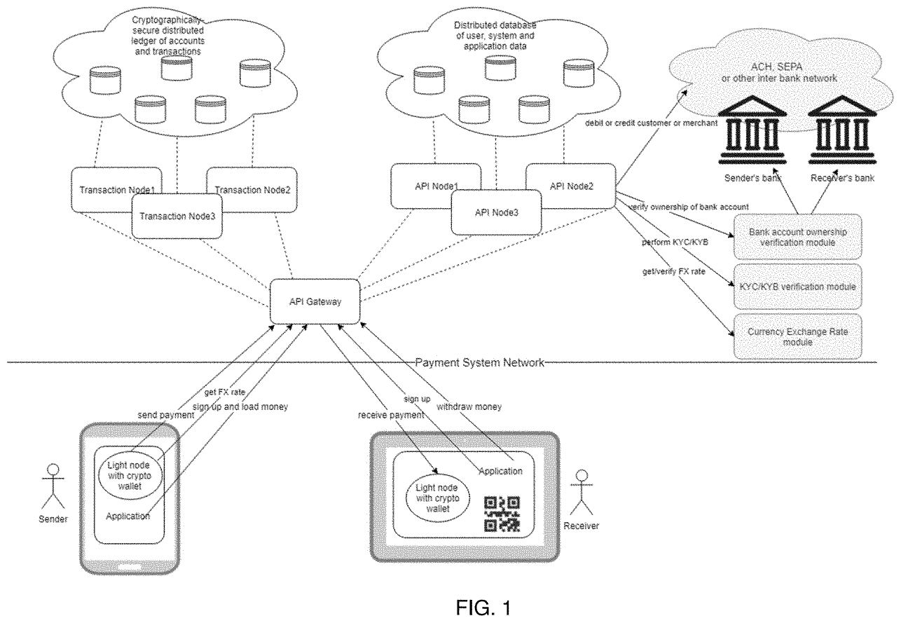

FIG. 1 shows the system and methods for national and/or cross-border payments using the hybrid architecture of centralized payment system and cryptographically secure distributed ledger. The system includes application programming interface (API) gateway and API nodes that are computing devices that process registration and authentication requests, requests to deposit and withdraw fiat currency, requests for KYC/KYB and bank account ownership verification, requests for currency exchange (FX) rate. It includes a database to store user, system and application data; it includes the Transaction nodes that are computing devices that validate and process transactions. It includes the distributed cryptographically secure ledger that stores the balances for each network participant and transaction details. The mobile and/or desktop application is connecting the Sender and Receiver to the API gateway. The built-in application wallet software is generating the user's pair of the private and public keys and connecting the user to the distributed ledger, where the public key serves as the user wallet address and the private key is kept privately on the user's device and serves to authorize digital assets transfers from the user to the merchant and/or peer to peer transfers. The Sender is signing with the wallet private key the sender's part of the transaction authorizing to spend the digital assets; the Receiver is signing with its wallet private key the receiver's part of the transaction to authorize acceptance of the digital assets. Then the transaction node validates the transaction, signs it and settles in the distributed ledger.

The API node is connected to KYC/KYB verification module to verify the client identity and Bank account ownership verification module to make sure that the person or entity owns the bank account that will be used to deposit and withdraw fiat funds. Also it is connected to the bank API, Automated Clearing House (ACH), and/or Single Euro Payments Area (SEPA) network or other means to make inter-bank transfers. Also the API node is connected to Currency Exchange Rate module to provide and validate the FX rate for cross-border transfers.

A distributed database of user, system and application data stores user's account data, digital wallet address mapping, and other data necessary to authenticate the user, to process account or key recovery requests, to perform transactions.

A cryptographically secure distributed ledger of accounts and transactions stores the balances for each network participant, transaction history and details, transaction requests, FX rate and other transaction related data. Cryptographically secure distributed ledger include multiple computing nodes that independently or in a centralized way record transactions and balances, then they agree with other nodes on the data to be persisted. Examples of distributed ledgers are blockchains, like Bitcoin, DAGs, Multi-chain structures, etc. Security is achieved by using cryptographic signatures made by the wallet owners holding the private key when they want to participate in transaction, and Merkle tree or hash tree structures where the next block contains the hash of the previous block and modification of a block will invalidate all blocks up to the head of the tree which ensures integrity.

Sender and/or Receiver flow starts with on boarding process, including registration, digital wallet generation and backup, going through KYC/KYB procedures, verifying bank account ownership, setting up multi factor authentication which may include biometric data, like fingerprint or face data, and/or pin, depositing funds and receiving digital assets from the system. Then the payments between the Sender and Receiver are done on-chain through the cryptographically secure distributed ledger which can be fast, secure and cost efficient.

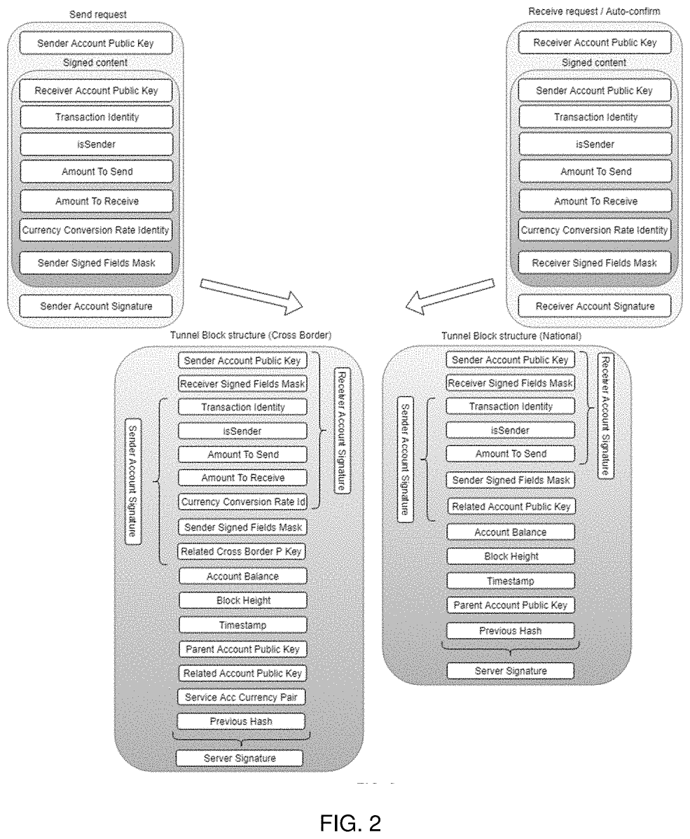

FIG. 2 shows Tunnel Multi-Chain block structure. The uniqueness of the structure is that it contains sender and receiver requests and that it is triple signed: by sender, by receiver, by transaction node. The first piece of data is the “Send request” which include the following fields: “Receiver Account Public Key” which is the address and the public key of the receiver, “Transaction Identity” which identifies the transaction, “isSender” which identifies if this is a request to send or to receive the assets, “Amount To Send” which is the amount of digital assets being sent in the sender's currency, “Amount To Receive” which is the amount of digital assets to be received by the receiver in the receiver's account currency, “Currency Conversion Rate Identity” is an optional field to identify the details of the provided FX rate, for example the rate validity period, “Sender Signed Fields Mask” which identifies the set of fields provided and signed in the “Send request”, “Sender Account Public Key” which is the address and the public key of the sender and “Sender Account Signature” which is a cryptographic signature made by the sender account holder private key for the fields: “Receiver Account Public Key”, “Transaction Identity”, “Amount To Send”, “Amount To Receive”, “isSender”, “Currency Conversion Rate Identity”, “Sender Signed Fields Mask”. The next piece of data is “Receive request/Auto-confirm” which contains the similar fields. The signed “Receive request/Auto-confirm” can be treated as the approval to receive digital assets and, in some cases, as a payment request. Normally the “Receive request/Auto-confirm” will have empty “Amount To Send” and “Currency Conversion Rate Identity”. Also, “Receive request/Auto-confirm” may have empty fields: “Transaction Identity”, “Amount To Receive”, “Sender Account Public Key” in order to Auto-confirm any incoming transactions or transactions from specific Senders, specific Transaction Ids or specific Amounts. “Tunnel Account Block” contains all the fields from the “Send request” and the “Receive request/Auto-confirm” and additional fields which, together with the fields from the “Send request” and “Receive request/Auto-confirm”, except sender and receiver signature fields, are all then signed by the transaction node private key. These additional fields are: “Account Balance” which is computed by the transaction node based on the “Amount To Send” or “Amount To Receive” and the previous account balance value, “Block Height” which is the block number in the sequence of blocks, “Timestamp” which is the transaction time recorded by the transaction node and “Previous Hash” which is the cryptographic hash (function like SHA-2) of the previous “Tunnel Account Block”, “Parent Account Public Key” which represents a group of accounts, “Related Account Public Key” which is the address where the digital assets are transferred to or received from, “Service Account Currency Pair” which identifies the currency pair of the service account for cross-border transactions. “Tunnel Account Block” for national payments has the same structure but does not have the extra fields. The signature of the block is stored in the “Server Signature” field. “Tunnel Account Block” is triple signed, it has “Receiver Account Signature”, “Sender Account Signature” and “Server Signature”.

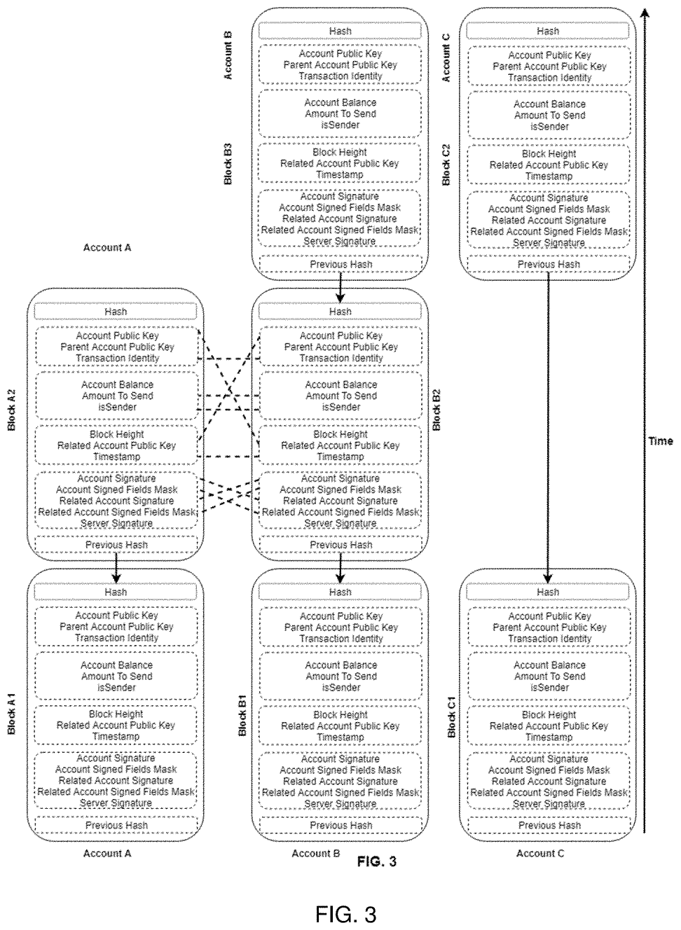

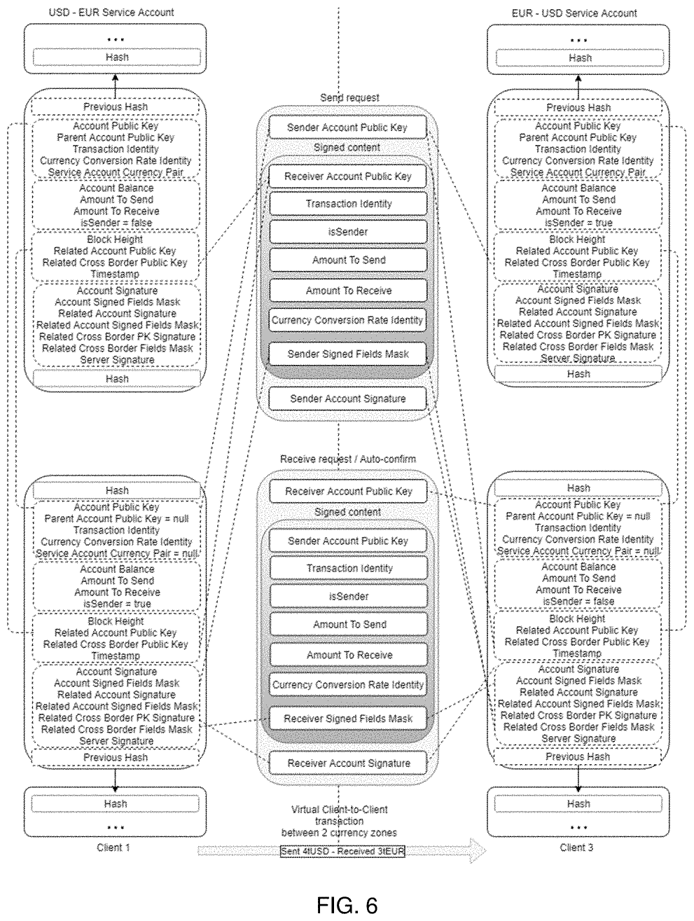

FIG. 3 shows Tunnel Multi-chain structure where each chain includes a series of Tunnel Account Blocks and represents an individual account and tracks balance changes. FIG. 3 demonstrates the structure for national payments where two accounts are involved in the transaction. The structure for cross-border payments is very similar but it has more fields and four accounts are involved in the transaction which will be covered below with the description of FIG. 6. It shows three accounts each having an individual chain of blocks. The chain has a sequence of blocks that are linked by means of cryptographic hash function like SHA-2: Previous Hash field of the next block contains the Hash of the previous block. Hash is not required to be stored, it can be calculated dynamically based on the content of the block. Each new block contains the updated total account balance, so the chain can be viewed as the history of balances (and maybe other state fields) where the top block has the actual account balance. Each block is triple signed by the sender, receiver and transaction node using the corresponding pairs of private and public keys. When a transaction between two accounts happens, two new head blocks are created with updated balances and the corresponding two chains are linked together, these two new blocks will have the same fields as in the “Send request” and “Receive request/Auto-confirm” and also the same “Timestamp” field. Note that “isSender” field should be true in the sender block and should be false in the receiver block. Different variations of the multi-chain block fields are possible, including, but not limited to: when two blocks are linked with a random number which is the same number in two blocks so that they can be matched, or Timestamp can be an optional field, etc. In the picture we can see that Account A had block A_1, Account B had block B_1, then transaction happened which resulted in construction of new blocks A_2 and B_2 and the link to denote the transaction. The picture also shows the next transaction between Account B and Account C which resulted in construction of blocks B_3 and C_2. It is to be understood that these details should not be interpreted as limiting. The key concept is that the block stores the total account balance and each account (or group of accounts) has a separate chain and that the block is triple signed by sender, receiver and transaction node. This data structure enables high scalability when transactions between accounts may happen in parallel.

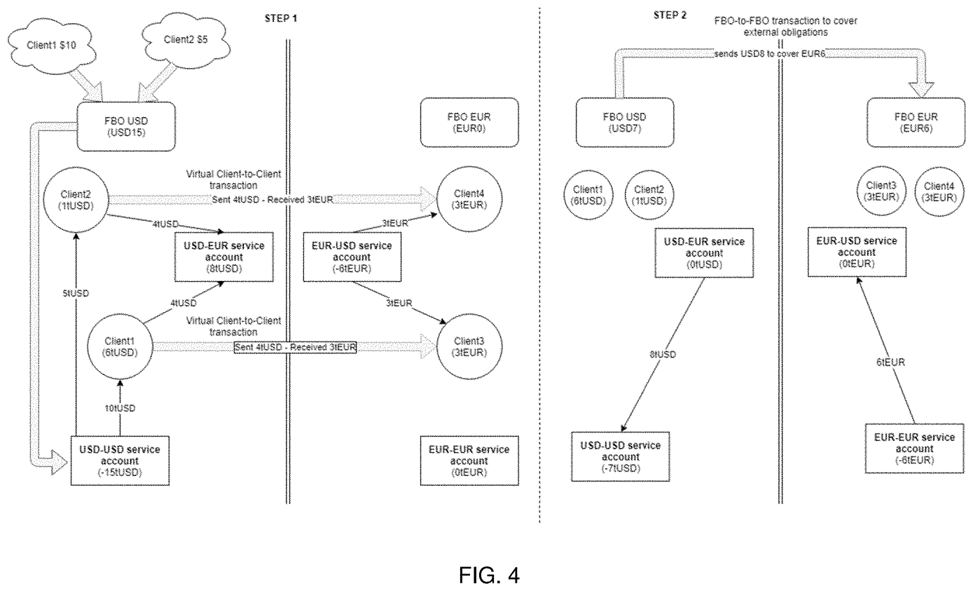

FIG. 4 shows the system and methods for the cross-border transaction flow in case the transactions in the distributed ledger are batched and then a single transfer between FBO accounts is made. In this example Client 1 deposits ten United States dollars (USD) to (For Benefit of) FBO account, Client 2 deposits five USD to FBO account. The total balance of FBO account is fifteen USD. The “USD-USD Service Account” deposits corresponding amount of the digital assets: Client 1 gets ten digital assets (USD nominated) and Client 2 gets five digital assets in his digital wallet. The total balance of the “USD-USD Service Account” is −15 digital assets. Client 3 and Client 4 are in EUR currency zone having zero balance. Let's say Client 1 transfers 4 digital assets (USD nominated) to Client 3, Client 3 receives three digital assets (EUR nominated). Let's say Client 2 transfers four digital assets (USD nominated) to Client 4, Client 4 receives three digital assets (EUR nominated).

To make cross-border transfer between Client 1 and Client 3, 4 accounts in the distributed ledger are involved: Client 1 account, “USD-EUR Service Account”, Client 3 account, “EUR-USD Service Account”. “USD-EUR Service Account” tracks how much assets USD currency zone owes to EUR currency zone, and is used for batching transactions. In the described transaction, Client 1 transfers four digital assets to “USD-EUR Service Account” and “EUR-USD Service Account” transfers three digital assets to Client 3. The left side of the figure shows the total balance of each account after both transfers are done.

The right side of the FIG. 4 shows the transfer between FBO accounts in two currency zones. As “USD-EUR Service Account” has a balance of eight digital assets, it owes them to EUR currency zone, so the transfer of eight USD from FBO in USD zone to FBO account in EUR zone is initiated. To cover obligation between two currency zones, three transactions happen as follows:
1) “USD-EUR Service Account” sends 8 digital assets to “USD-USD Service Account.”
2) “EUR-EUR Service Account” sends 6 digital assets to “EUR-USD Service Account.”
3) The bank transfers 8 USD from FBO in USD zone, the bank receives 6 EUR in FBO in EUR zone. The right side of the figure shows the total balance of each account after all obligations are covered.

Note that to enable scalability of the transactions, there are many service accounts of each type which are selected randomly, using round-robin or other method.

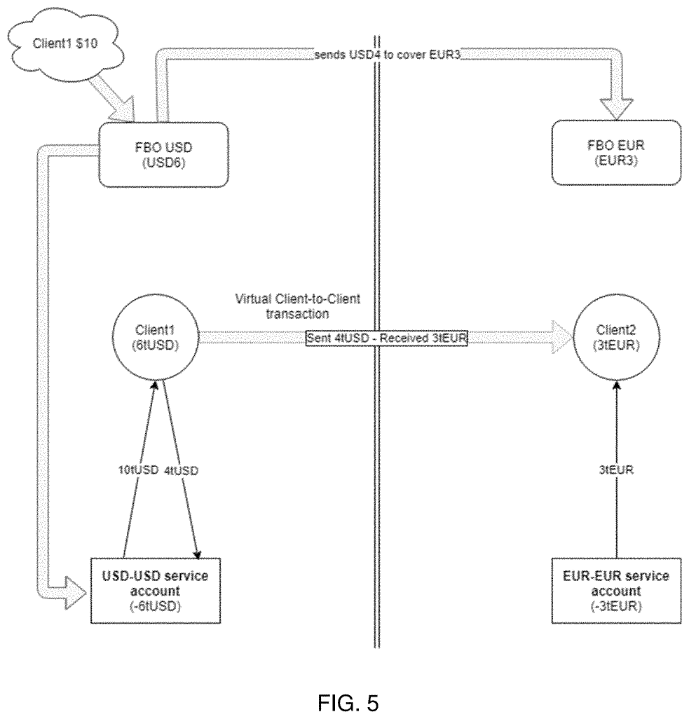

FIG. 5 shows the system and methods for the cross-border transaction flow in case the transactions in the distributed ledger are not batched and every transaction updates FBO accounts balances. In this example Client 1 deposits ten USD to FBO account. The total balance of FBO account is ten USD. The “USD-USD Service Account” deposits corresponding amount of the digital assets: Client 1 gets ten digital assets (USD nominated) in his digital wallet. The total balance of the “USD-USD Service Account” is minus ten digital assets. Client 2 is in EUR currency zone having a zero balance. Let's say Client 1 transfers four digital assets (USD nominated) to Client 2, Client 2 receives three digital assets (EUR nominated).

To make cross-border transfer between Client 1 and Client 2, 4 accounts in the distributed ledger are involved: Client 1 account, “USD-USD Service Account”, Client 2 account, “EUR-EUR Service Account”. “USD-USD Service Account” tracks how much assets USD currency zone owes to its clients in the same currency zone. In the described transaction, Client 1 transfers four digital assets to “USD-USD Service Account” and “EUR-EUR Service Account” transfers three digital assets to Client 2. As there is no transaction batching in this example and every transaction needs to be reflected in the balance of FBO accounts, the bank transfers four USD from FBO in USD zone, the bank receives three EUR in FBO in EUR zone. FIG. 5 shows the total balance of each account after the transfer.

Note that to enable scalability of the transactions, there are many service accounts of each type which are selected randomly, using round-robin or other method.

FIG. 6 shows Tunnel Multi-chain structure where each chain includes a series of Tunnel Account Blocks and represents an individual account and tracks balance changes. This figure demonstrates the structure for cross-border payments where 4 accounts are involved in the transaction. The structure for cross-border payments is very similar to the structure for national payments described in FIG. 3 but it has more fields and four accounts are involved in the transaction. It shows four accounts (as described in FIG. 4): “USD-EUR Service Account”, “Client 1”, “Client 3”, “EUR-USD Service Account”, each having an individual chain of blocks. The chain has a sequence of blocks that are linked by means of cryptographic hash function like SHA-2: Previous Hash field of the next block contains the Hash of the previous block. Hash is not required to be stored. It can be calculated dynamically based on the content of the block. Each new block contains the updated total account balance, so the chain can be viewed as the history of balances (and maybe other state fields) where the top block has the actual account balance. Each block is triple signed by the sender, receiver and transaction node using the corresponding pairs of private and public keys. When a cross-border transaction happens, four new head blocks are created with updated balances and the corresponding four chains are linked together, these four new blocks will have the same fields as in the “Send request” and “Receive request/Auto-confirm” and also the same “Timestamp” field. Note that “isSender” field should be true in the sender block and should be false in the receiver block. As described in FIG. 4, the transfer is done between “USD-EUR Service Account” and Client 1, and between “EUR-USD Service Account” and Client 3. “USD-EUR Service Account” plays the role of proxy and should continue the transfer for the benefit of the final recipient which is in another currency zone. The field “Related Cross-Border Public Key” contains the address of the final beneficiary of the transfer and the field “Related Account Public Key” contains the address of the direct sender/receiver. “Parent Account Public Key” is typically set for the service accounts as they are grouped for the purpose of scalability. “Service Account Currency Pair” identifies the currency pair of the service account for cross-border transactions. FIG. 6 shows how different fields are mapped from the “Send request” and “Receive request/Auto-confirm” to the four new blocks in different accounts. Different variations of the multi-chain block fields are possible, including, but not limited to: when blocks are linked with Transaction Identity which is the same value in four blocks so that they all can be matched and there is no field values redundancy (currently FIG. 6 has some fields redundancy to optimize for db reads which is optional), or Timestamp can be an optional field, etc. In the picture we can see that four accounts had previous blocks, then transaction happened which resulted in construction of four new head blocks—one per each of the four accounts. It is to be understood that these details should not be interpreted as limiting. The key concept is that the block stores the total account balance and each account (or group of accounts) has a separate chain and that the block is triple signed by sender, receiver and transaction node. This data structure enables high scalability when transactions between accounts may happen in parallel.

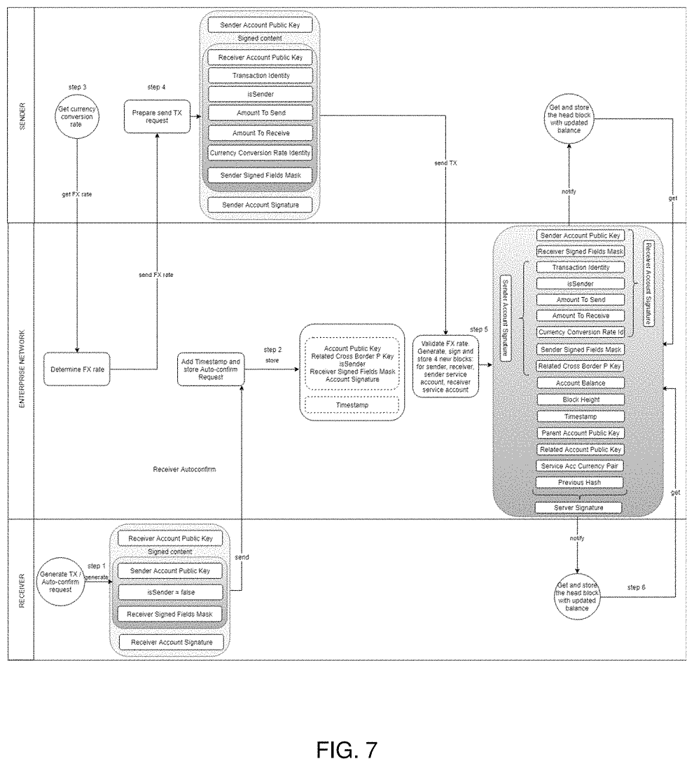

FIG. 7 shows the system and methods for the main transaction flow in case the receiver sends Auto-confirm for the specific sender.

In Step 1: The Receiver device generates and sends Auto-confirm request to the Tunnel Enterprise Network to automatically accept all transactions from the specific sender. The “Receive request/Auto-confirm” contains 3 fields: “Sender Account Public Key”, “isSender”, “Receiver Signed Fields Mask” which are signed by the receiver's private key. The “Receiver Account Public Key” and “Receiver Account Signature” are added into the message as authorization to accept incoming digital assets.

In Step 2: The transaction node receives the “Receive request/Auto-confirm”, adds “Timestamp” and stores the data.

In Step 3: The Sender gets FX rate by calling the API node

In Step 4: The Sender device generates and sends the “Send request” to the Tunnel Enterprise Network to make a cross-border transfer. The “Send request” contains seven fields: “Receiver Account Public Key”, “Transaction Identity”, “isSender”, “Amount To Send”, “Amount To Receive”, “Currency Conversion Rate Identity” (optional), “Sender Signed Fields Mask” which are signed by the sender's private key. The “Sender Account Public Key” and “Sender Account Signature” are added into the message as authorization to spend the digital assets. Note that “Amount To Send” is set to amount of the assets in the sender's account currency and “Amount To Receive” is calculated based on the FX rate and “Amount To Send”. The ratio of “Amount To Send” and “Amount To Receive” should correspond to the FX rate which will be validated by the Enterprise Network.

In Step 5: The transaction node receives the “Send request” and uses it and the “Receive request/Auto-confirm” to generate 4 new blocks—one for sender account chain, one for receiver account chain, one for service account in the sender's currency zone, one for service account in the receiver's currency zone. First it performs validations including that the sender has enough digital assets in the account, and that the FX rate is correct. Then it calculates the new balances for 4 accounts and adds the “Account Balance” field into the blocks. It calculates “Block Height” by incrementing the previous block's “Block Height” and adds into the block. It adds the same “Timestamp” into the both blocks. It calculates “Previous Hash” for the 4 blocks by calculating the hash functions based on the previous block. The “Receive request/Auto-confirm” data, the “Send request” data and the 7 additional fields are then signed by the private key (“Server Signature” field) of the transaction node as an authorization to settle the transaction.

In Step 6: The Sender and Receiver devices are notified on the transaction settlement and stores locally the new head block with the updated balance.

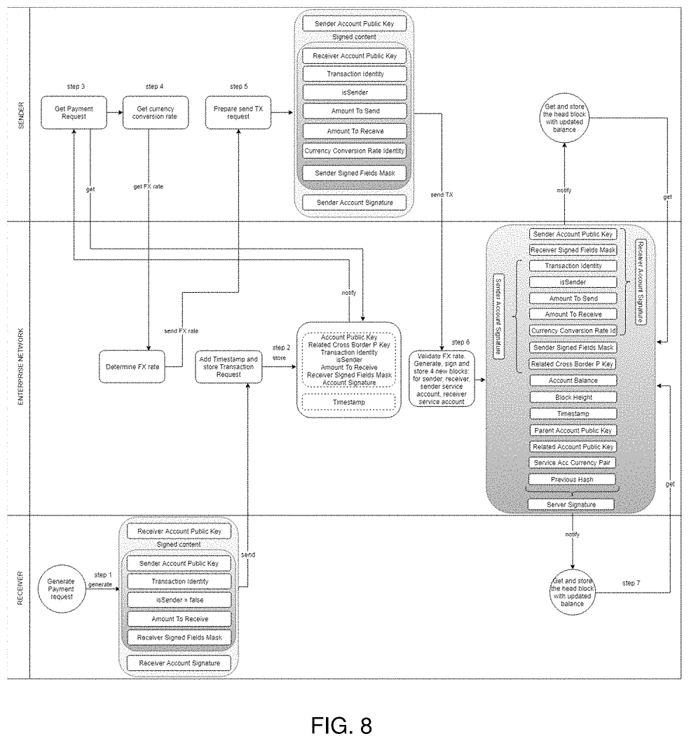

FIG. 8 shows the system and methods for the main transaction flow in case the receiver sends the payment request for the specific sender.

In Step 1: The Receiver device generates and sends the payment request to the Tunnel Enterprise Network to request specific amount of digital assets from the specific sender. The “Receive request/Auto-confirm” contains five fields: “Sender Account Public Key”, “isSender”, “Receiver Signed Fields Mask”, “Transaction Identity”, “Amount To Receive” which are signed by the receiver's private key. The “Receiver Account Public Key” and “Receiver Account Signature” are added into the message as authorization to accept incoming digital assets.

In Step 2: The transaction node receives the “Receive request/Auto-confirm”, adds “Timestamp” and stores the data.

In Step 3: The Sender gets notified about payment request and gets the payment request details from the Enterprise Network.

In Step 4: The Sender gets FX rate by calling the API node

In Step 5: The Sender device generates and sends the “Send request” to the Tunnel Enterprise Network to make a cross-border transfer. The “Send request” contains 7 fields: “Receiver Account Public Key”, “Transaction Identity”, “isSender”, “Amount To Send”, “Amount To Receive”, “Currency Conversion Rate Identity” (optional), “Sender Signed Fields Mask” which are signed by the sender's private key. The “Sender Account Public Key” and “Sender Account Signature” are added into the message as authorization to spend the digital assets. “Amount To Send” is set to amount of the assets in the sender's account currency and is calculated based on the “Amount To Receive” and on the FX rate. The ratio of “Amount To Send” and “Amount To Receive” should correspond to the FX rate which will be validated by the Enterprise Network.

In Step 6: The transaction node receives the “Send request” and uses it and the “Receive request/Auto-confirm” to generate 4 new blocks—one for sender account chain, one for receiver account chain, one for service account in the sender's currency zone, one for service account in the receiver's currency zone. First it performs validations including that the sender has enough digital assets in the account, and that the FX rate is correct. Then it calculates the new balances for 4 accounts and adds the “Account Balance” field into the blocks. It calculates “Block Height” by incrementing the previous block's “Block Height” and adds into the block. It adds the same “Timestamp” into the both blocks. It calculates “Previous Hash” for the 4 blocks by calculating the hash functions based on the previous block. The “Receive request/Auto-confirm” data, the “Send request” data and the 7 additional fields are then signed by the private key (“Server Signature” field) of the transaction node as an authorization to settle the transaction.

In Step 7: The Sender and Receiver devices are notified on the transaction settlement and stores locally the new head block with the updated balance.

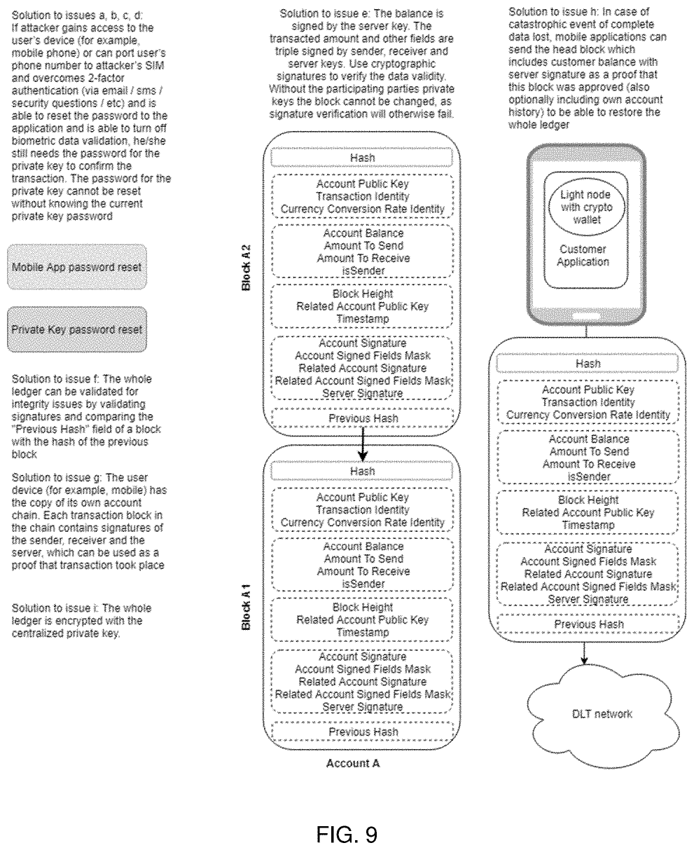

FIG. 9 shows the system and methods to solve security issues (e.g. Security issues A through I below) that existing payment systems may have:

Security issue A, attacker contacts the phone provider and, by pretending to be the phone number owner, asks to port the number to his SIM. Then the attacker is able to reset the password to the payment application overcoming 2-factor authentication, like reading SMS and can spend other person's money.

Security issue B, attacker steals mobile device, overcomes 2-factor authentication and after successful reset password procedure can spend other person's money (2-factor authentication like SMS and email may not work well as person with access to the phone usually has access to read SMS and access to email client without the need to enter additional password).

Security issue C, attacker steals mobile device, overcomes security questions, and after successful reset password procedure can spend other person's money (security questions may not be secure enough, as attacker can use the person's social media profiles to figure out the answers).

Security issue D, attacker gains access to the mobile device where payment application is secured by application password and biometric data validations, overcomes 2-factor authentication (same as Security Issue B and C), and gains the access to the payment system database to disable biometric data validations. As a result the attacker can spend the person's money.

Security issue E, attacker gains the access to the database and changes the balance (or other data) in a way that will be unnoticeable to the system.

Security issue F, in case of a data loss event, it may be hard to identify integrity issues.

Security issue G, in case of a data loss event, it may be hard for the customers to prove that the lost transaction took place.

Security issue H, attacker gains the access to the databases and destroys the data including the backups.

Security issue I, attacker gains the access to Customers and Merchants balances and other data.

Solution for security issues A through D: if attacker gains access to the user's device (for example, mobile phone) or can port user's phone number to attacker's SIM and overcomes 2-factor authentication (via email/SMS/security questions/etc.) and is able to reset the password to the application and is able to turn off biometric data validation, he/she still needs the password for the private key to confirm the transaction. The password for the private key cannot be reset without knowing the current private key password.

Solution for security issue E: The balance is signed by the server key. The transacted amount and other fields are triple signed by sender, receiver and server keys. Cryptographic signatures should be used to verify the data validity. Without the participating parties private keys the block cannot be changed, as signature verification will otherwise fail.

Solution for security issue F: The whole ledger can be validated for integrity issues by validating signatures and comparing the “Previous Hash” field of a block with the hash of the previous block.

Solution for security issue G: The user device (for example, mobile) has the copy of its own account chain. Each transaction block in the chain contains signatures of the sender, receiver and the server, which can be used as a proof that transaction took place

Solution for security issue H: In case of catastrophic event of complete data lost, application on users devices (such as mobile phones, tablets, PCs, etc.) can send the head block which includes customer balance and signatures of validating nodes that approved this block and also can send account history. This data can be used to restore the whole ledger and/or verify customer's balance.

Solution for security issue I: The whole ledger is encrypted with the centralized private key.

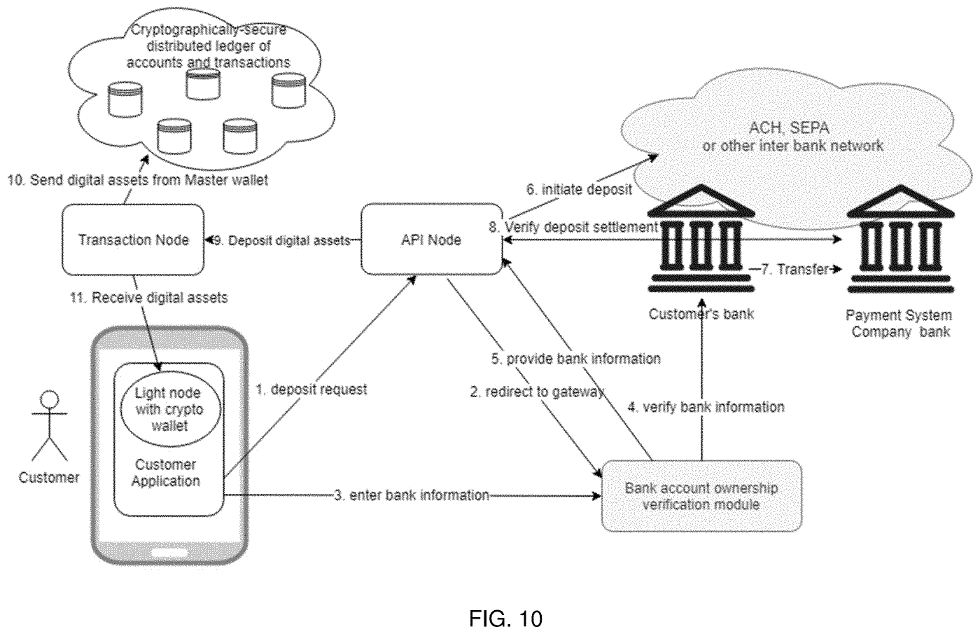

FIG. 10 shows the cost effective system and methods to deposit/withdraw fiat currency into/from the system with conversion to digital assets. The system includes the user device, API Node which is a computing node that processes requests, Transaction Node which is a computing node that processes transactions and has Payment System Master wallet program module installed, cryptographically secure distributed ledger of accounts and transactions which is a network of computing nodes that stores transaction data, a module to verify bank account ownership, connection to the bank network via bank API. The Customer, after registration and completing KYC/KYB procedure, submits a deposit request and authorization to the API Node from the software installed on his/her device (for example, mobile phone). The API Node redirects the user to the Bank account ownership verification module from where the user can prove the bank account ownership. For example, the user can login to the mobile banking account through the module, and the module can return the account data and handle to the API Node. The API Node, using the Customer bank information, initiates the transfer of fiat currency from the Customer's bank to the Payment System Company bank using ACH network, bank API or other cost effective means. Once the API Node gets notified (or verifies through periodic account check) that the fiat currency settled, it requests the transaction node to perform the transfer of digital assets from the Payment System Master wallet to the Customer's digital wallet (installed on his device). The transaction node performs the necessary validations and generates the new blocks with updated balances for the Customer's account chain and Master wallet chain. The Customer's device receives the new block with updated balance based on the transferred fiat currency. Withdrawal of the fiat funds works in the similar way: the user initiates withdrawal and sends digital assets to the master wallet, and the API node submits the equivalent fiat currency transfer from the Payment System company bank to the Customer's bank. Cost efficiency of overall process is achieved by using cost efficient inter-bank transaction (such as ACH transaction or other cost efficient method), waiting for the fiat transaction to settle which ensures the Customer possesses the funds in the bank account, the process of getting funds transfer authorization and bank account ownership verification which minimized the probability of a charge back, using Tunnel Mutli-Chain to settle deposit of digital assets virtually at no cost with high security, integrity and high throughput.

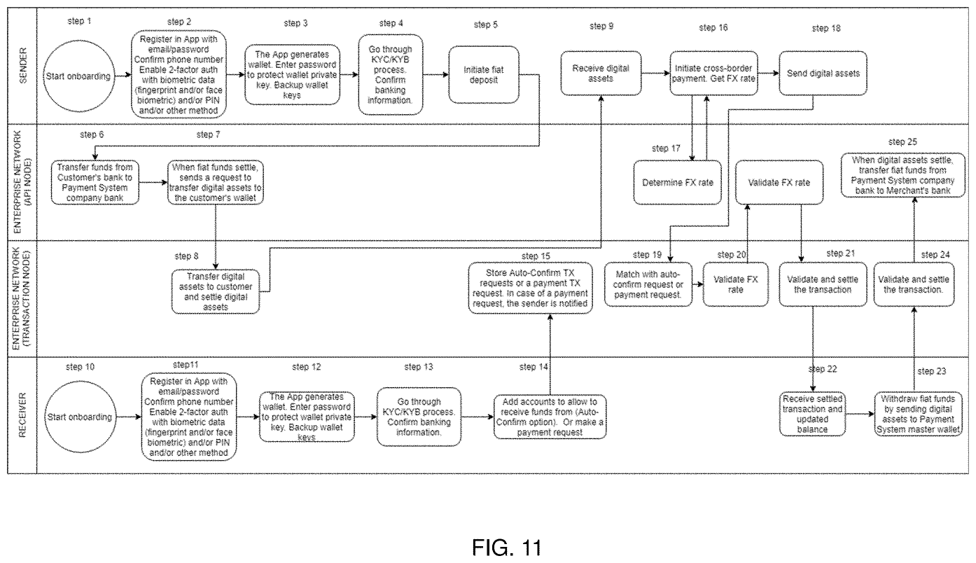

FIG. 11 shows the system with end to end flow for cost effective cross-border payments with high security and high throughput.

In Step 1: The Sender starts on boarding process.

In Step 2: The Sender registers in the application with email and password, confirms the phone number and phone number ownership, enables multi-factor authentication with biometric data (fingerprint and/or face data) and/or PIN and/or other method

In Step 3: The application generates digital assets wallet. The Sender enters the password to protect the wallet private key. The Sender backups the wallet private key.

In Step 4: The Sender goes through KYC/KYB process. The Sender confirms banking information and proves the bank account ownership.

In Step 5: The Sender initiates deposit of fiat currency.

In Step 6: The system transfers funds from the Sender's bank to the Payment System company bank.

In Step 7: When fiat currency transfer settles, the API Node sends a request to Transaction Node to transfer corresponding value of digital assets to the Sender's digital wallet.

In Step 8: The Transaction Node transfers digital assets to the Sender's digital wallet and settles the transaction.

In Step 9: The Sender gets notified about receiving the digital assets.

In Step 10: The Receiver starts on boarding process.

In Step 11: The Receiver registers in the application with email and password, confirms the phone number and phone number ownership, enables multi-factor authentication with biometric data (fingerprint and/or face data) and/or PIN and/or other method.

In Step 12: The application generates digital assets wallet. The Receiver enters password to protect the wallet private key. The Receiver backups the wallet private key.

In Step 13: The Receiver goes through KYC/KYB process. The Receiver confirms banking information and proves the bank account ownership.

In Step 14: The Receiver adds accounts from which he/she is willing to accept transfers from (the similar option is the payment request) and sends the preferences to the Transaction Node.

In Step 15: The Transaction Node stores the Auto-confirm request.

In Step 16: The Sender initiates the cross-border transaction. The Sender requests FX rate from the API node.

In Step 17: The API node determines FX rate and returns to the Sender

In Step 18: The Sender sends digital assets by submitting a signed “Send request” to the Transaction Node.

In Step 19: The Transaction Node matches the “Send request” with “Receive request/Auto-confirm”.

In Step 20: The Transaction Node validates the FX rate

In Step 21: The Transaction Node validates and settles the transaction

In Step 22: The Receiver gets notified about receiving the digital assets.

In Step 23: The Receiver initiates request to withdraw fiat currency. The Receiver sends digital assets to Payment System master wallet.

In Step 24: The Transaction Node validates and settles the transaction.

In Step 25: When digital assets are settled, the API node transfers fiat funds from the Payment System company bank to the Receiver's bank.

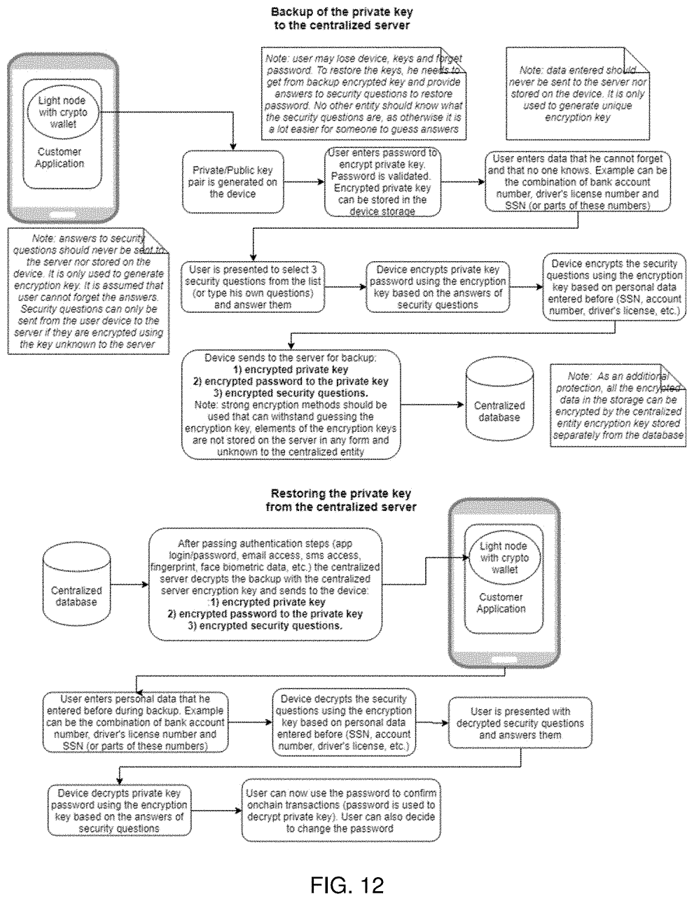

FIG. 12 shows the system and methods to securely backup and restore the wallet private keys to/from the centralized system. The system includes the user device (mobile phone, tablet, PC, or any other computing device), the server with storage (a database as an example). The user device has a pair of public and private keys generated. The user enters the password to encrypt the private key so that the private key can be stored encrypted in the device storage. The system validates the password.

The problem may occur if the user loses the device and/or loses the keys and/or forgets the password. Existing methods to do backup of the private key include writing down the key itself on the paper, or writing down 12 to 24 mnemonic words on the paper, or writing down the password, and keeping the paper in a secure location. This is not convenient for majority of people as it requires thinking about at least two secure locations to keep the secret.

Disclosed is a method to backup the private key securely in the centralized trusted storage in a way that if the centralized storage leaks the data (or the database is hacked). It will be computationally infeasible to guess the password to decrypt the private key, assuming the password is strong, and at the same time the user can restore the private key from the backup even if he/she forgets the password.

The method includes the user entering the combination of data that he/she cannot forget and that no one knows. Example can be the combination of bank account number, driver's license number and Social Security Number (SSN) or parts of these numbers. Then the user is presented to select 3 security questions from the list (or type his own questions; it is recommended or required to type at least one own question) and the user answers them. It is important that combination of data that user has entered (for example, bank account number, driver's license number and SSN) and the answers to security questions are not sent to the centralized storage nor is stored on the user device. It is also important that the selected/typed security questions can only be sent to the centralized storage encrypted with the key that is not known to the server. It may not be impossible to guess the answers to security questions but it is infeasible to answer the questions without knowing the questions. It is assumed that the user can look up his bank account number, SSN and driver's license number, or other data, and that the user remembers the answers to security questions and they are hard to guess. The user device encrypts private key password using the encryption key based on the answers of security questions. Then the user device encrypts the security questions using the encryption key based on personal data entered before (SSN, account number, driver's license, etc.). Then the user device sends to the centralized storage for backup:

1) encrypted private key

2) encrypted password to the private key

3) encrypted security questions.

Note: strong encryption methods should be used that can withstand guessing the encryption key, elements of the encryption keys are not stored on the server in any form and unknown to the centralized entity. Key stretching algorithm, like Scrypt, or others, should be used with appropriate parameters to slow down brute-force attack so that it becomes computationally infeasible and strong encryption algorithm, like AES-256 or others, should be used.

Since the centralized entity (or the attacker if the centralized database data leaks) does not know the security questions nor the data used to encrypt the questions, also, as a result, does not know the answers to security questions, it is computationally infeasible to guess the key to decrypt the password or to guess the password to decrypt the private key, assuming that the original password is strong.

As an additional protection, all the encrypted data in the storage can be encrypted by the centralized entity encryption key stored separately from the database. Also the user can get data from the server after passing all the authentication steps, including multi-factor authentication and/or verifying biometric data.

The private key restoration procedure contains the following steps below. After passing authentication steps (application login/password, email access, access to phone to read SMS, fingerprint, face biometric data, etc.) the centralized server decrypts the backup with the centralized server encryption key and sends to the device:

1) encrypted private key

2) encrypted password to the private key

3) encrypted security questions.

The user enters personal data that he/she entered before during backup procedure: example can be the combination of bank account number, driver's license number and SSN (or parts of these numbers). The user device decrypts the security questions using the encryption key based on personal data entered before (SSN, account number, driver's license, etc.). The user is presented with decrypted security questions and then the user answers them. The user device decrypts the private key password using the encryption key based on the answers of security questions. The user can now use the password to confirm on-chain transactions (password is used to decrypt the private key). The user can also decide to change the password.

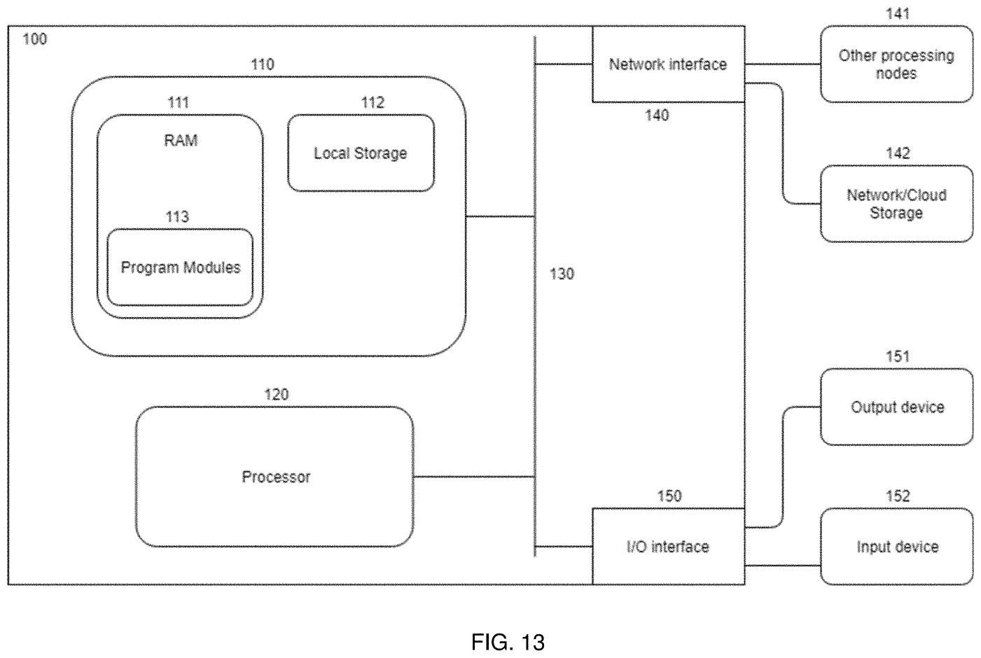

FIG. 13 illustrates one example of a system to implement the subject matter disclosed herein, including sending/receiving national and/or cross-border payments, depositing/withdrawal of the fiat currency, backup/restore the private key, processing and validating a payment transaction. It includes computing hardware device 100, which has a processor 120, memory 110, network interface 140, I/O interface 150 and a bus 130 which connects these parts.

The memory 110 may include random access memory (RAM) 111 or any other type of volatile memory, local disk storage 112 including hard disk drive, SSD or any other type of non-volatile memory. Program modules 113 are loaded into RAM which may include Operating System, program data and program executable instructions.

The processor 120 together with the memory 110 implements the data structures and methods described in FIGS. 1 through 12. The described above executable instructions and data are loaded from the local storage 112 into RAM memory 111 and processed by the processor 120. The computer system has I/O interface 150 to read user input from Input device 152 including, but not limited to, keyboard or mouse pointing device or fingerprint reader or face data reader or quick response (QR) scanner etc., and to display the result on Output device 151 including, but not limited to, monitor or printer. Network interface 140 is used by the system to communicate with other processing nodes 141 that can participate in transactions or perform other requests or with network storage devices 142. The bus 130 links memory 110, processor 120, network interface 140 and I/O interface 150. The bus 130 represents one or more bus structures, including but not limited to, memory bus, local bus, peripheral bus, etc.

It should be understood that the methods defined in the claims and above can be implemented entirely as a hardware component, for example as a specialized circuits, entirely as a software component or a combination of both. It is to be understood that

FIG. 13 illustrates one possible implementation and other variations are possible which may include any combination of any hardware components, thus the example should not be considered as limiting.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for a national payment or a cross-border payment using a hybrid architecture of a centralized payment system having a database to store user data and application data, a cryptographically secure distributed ledger with triple signed blocks, and a master wallet, the computer implemented method comprising:
registering a user, by a processor, by a user device and by a connected application programming interface (API) server, in a device application by capturing input from a user, and processing the data, wherein the user device is at least one of a sender user device and a receiver user device;
generating by the processor and by the user device a pair of public keys and a pair of private keys for a client wallet;
encrypting by the processor and by the user device a wallet private key with a wallet password entered by the user;
connecting, by the processor and network interface, to a “Know Your Customer”/“Know Your Business” (KYC/KYB) verification entity to verify a client identity;
connecting by the processor and a network interface to a bank account ownership verification entity to confirm bank account ownership for depositing or withdrawing fiat currency;
processing by the processor and by the API server, a Customer's fiat currency deposit request by using a bank API, Automated Clearing House (ACH) network, or a Single Euro Payments Area (SEPA) network to make inter-bank transfers;
processing, by the processor and by a transaction node, the cryptographically secure distributed ledger, and master wallet device, a transfer of digital assets from the master wallet to the client wallet;
generating a Receiver's transaction part by the processor and by a Receiver's device, by specifying accounts to allow to automatically accept funds from or by generating a “Payment request”, signing a Receiver's part of a transaction by the wallet private key and sending to the transaction node;
connecting, by the processor and network interface, by a Sender's device to currency exchange rate module to get currency exchange rate when initiating the cross-border payment;
generating a Sender's part of the transaction, by the processor, by the Sender's device, by processing the payment request (such as scanning QR code, or getting request data from the transaction node, or with other method) or manually entering transaction data, specifying a Receiver's wallet address, amount to pay and other data, creating a Send request and signing by the wallet private key and sending to the transaction node;
validating, by the processor, by the transaction node the transaction and currency exchange rate, if provided, generating new blocks with updated balances for participating accounts, signing them with a transaction node private key and storing in the cryptographically secure distributed ledger;
processing, by the processor, by the transaction node, distributed ledger, user device and master wallet device, the transfer of digital assets from the client wallet to Payment System master wallet; and
processing by the processor and by the API server a client's fiat currency withdrawal request by using the bank API, the ACH network, or the SEPA network to make inter-bank transfers.

2. The computer implemented method of claim 1, wherein:
the hybrid architecture includes a Tunnel Multi-Chain computer-based memory structure for computing nodes in a distributed ledger; and
the Tunnel Multi-Chain computer-based memory structure comprises:
a memory; and
a set of chains stored in the memory, wherein:
each chain represents an individual account and configure to track balance changes and includes a series of account blocks;
each block is triple signed by a sender, a receiver and a server as approval by all parties; and
each block is linked to a previous block by a hash function for integrity.

3. The computer implemented method of claim 2 further comprising:
authenticating to a server using cryptographic signatures instead of passwords;
verifying by the processor and by the transaction node the cryptographic signatures to confirm no changes by an attacker;
verifying, by the processor, a signature of each block and comparing a “Previous Hash” of each block with a “Hash” of the previous block to identify integrity issues;
encrypting the distributed ledger; and
sending by the processor and network interface, by the user device an account head block with account history to the server to restore the cryptographically secure distributed ledger and verify a customer balance.

4. The computer implemented method of claim 3 further comprising:
batching cross-border transactions within the cryptographically secure distributed ledger using special service accounts; and
making a single For Benefit Of (FBO)-to-FBO account transfer to cover accumulated obligations between two currency zones.

5. The computer implemented method of claim 3, wherein:
cross-border transactions within the cryptographically secure distributed ledger are not batched; and
each cross-border transaction within the cryptographically secure distributed ledger is accompanied by a For Benefit Of (FBO)-to-FBO account transfer between two currency zones.

6. The computer implemented method of claim 1, wherein the input from the user includes at least one of an email and an application password, a phone number, and a multi-factor authentication.

7. The computer implemented method of claim 6, wherein the multi-factor authentication includes at least one of biometric data and pin data.

8. The computer implemented method of claim 1 further comprising securely storing private wallet keys to protect against device loss or a forgotten password.

9. The computer implemented method of claim 1, wherein processing the payment request includes scanning a quick response (QR) code or getting request data from the transaction node.
